(19) United States
(12) Patent Application Publication
(10) Pub. No.: US 2005/0175401 A1
(43) Pub. Date: Aug. 11, 2005

(54) Garage door drive

(76) Inventor: Michael Hoermann, Oerlinghausen (DE)

Correspondence Address: Jeffrey S. Steen, Esq.;Carter, Deluca, Farrell & Schmidt, LLP, Suite 225, 445 Broad Hollow Road, Melville, NY, 11747, US

(21) Appl. No.: 10/845,893

(22) Filed: May 14, 2004

(30) Foreign Application Priority Data
Jan. 26, 2004 (DE) 20 2004 001 119.0

(51) Int. Cl. B25G 3/18

(52) U.S. Cl. 403/326

(57) ABSTRACT

The invention relates to a garage door drive comprising a guide rail for the receiving of a drive means and a drive unit arranged in a housing, with the guide rail being releasably connectable to the housing. In accordance with the invention, the guide rail can be fixed to the housing by latching tongues formed on it and latchable into corresponding molded elements arranged on the housing or by at least one C-shaped holding clip engaging around the guide rail and latchable into corresponding molded elements arranged at the housing.

The invention relates to a garage door drive comprising a guide rail for the receiving of a drive means and a drive unit arranged in a housing, with the guide rail being releasably connectable to the housing.

The guide rails of garage door drives are connected on the motor side to the drive units in which the geared motor is located. The translation of the rotational movement of the motor shaft into the linear movement of the guide carriage takes place between the guide rail and the drive unit. The guide carriage is connected in this process to the geared motor via chains, roller chains, toothed belts or the like and via the deflection toothed wheel or the deflection pinion.

The guide rails of garage door drives are very frequently C-shaped steel rails which are screwed to the housing of the drive unit via C-shaped steel metal clamps. The assembly using such steel metal clamps is complicated and expensive, particularly since it has to take place overhead on the ceiling of the garage due to the arrangement of the guide rail and of the drive

It is the object of the invention to simplify the assembly of guide rails on the drive unit housing of garage door drives.

The object is solved in accordance with the invention by the combination of the features of claim 1. Accordingly, starting from a generic garage door drive comprising a guide rail for the receiving of a drive means and a drive unit arranged in a housing, with the guide rail being releasably connectable to the housing, the guide rail is fixed to the housing, according to one solution, by at least one C-shaped holding clip which engages around the guide rail and can be latched into corresponding molded elements arranged at the housing. In accordance with another solution, the guide rail is fixed to the housing by latching tongues formed on it and latchable into corresponding molded elements arranged on the housing. The connection is thus pluggable between the guide rail and the drive unit, whereby a fast installation or a fast dismantling is made possible. No further securing means such as screws are required beyond this for the installation. In accordance with the last alternative, the connection can be carried out directly in a latching manner between the guide rail and the housing of the drive unit. Alternatively to this, a C-shaped holding clip engaging around the guide rail and latchable into molded elements correspondingly arranged in the housing can, however, also be used within the framework of the invention.

Special aspects of the invention result from the dependent claims subsequent to the main claim.

When a C-shaped holding clip is used, resilient webs can adjoin the lateral limbs of said C-shaped holding clip.

Latch elements can be molded to the resilient webs and engage into corresponding latch elements of the molded elements on the housing side.

A respective tongue can adjoin the resilient webs at the side.

A screw bore can additionally be cut out in the tongue for the receiving of a safety screw which is, however, not required for the installation itself.

The outer rim of the tongue can advantageously be reinforced and/or grooved.

A protective wall can be molded to the housing itself and surrounds the inserted resilient webs, with the optionally provided rim of the tongue adjoining the resilient web projecting beyond a cut-out provided in the protective wall.

Both the holding clip and the housing advantageously consists of plastic.

Further features, details and advantages of the invention will be explained with reference to an embodiment shown more closely in the drawing. There are shown:

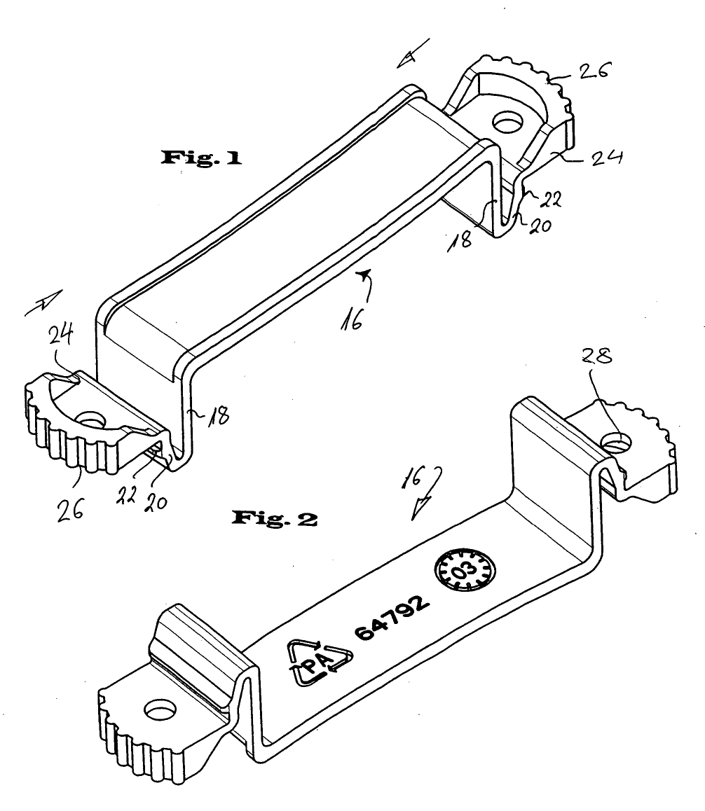

FIG. 1: a perspective view of a C-shaped holding clip in accordance with the present invention;

FIG. 2: a perspective view of the clip in accordance with FIG. 1 from another side;

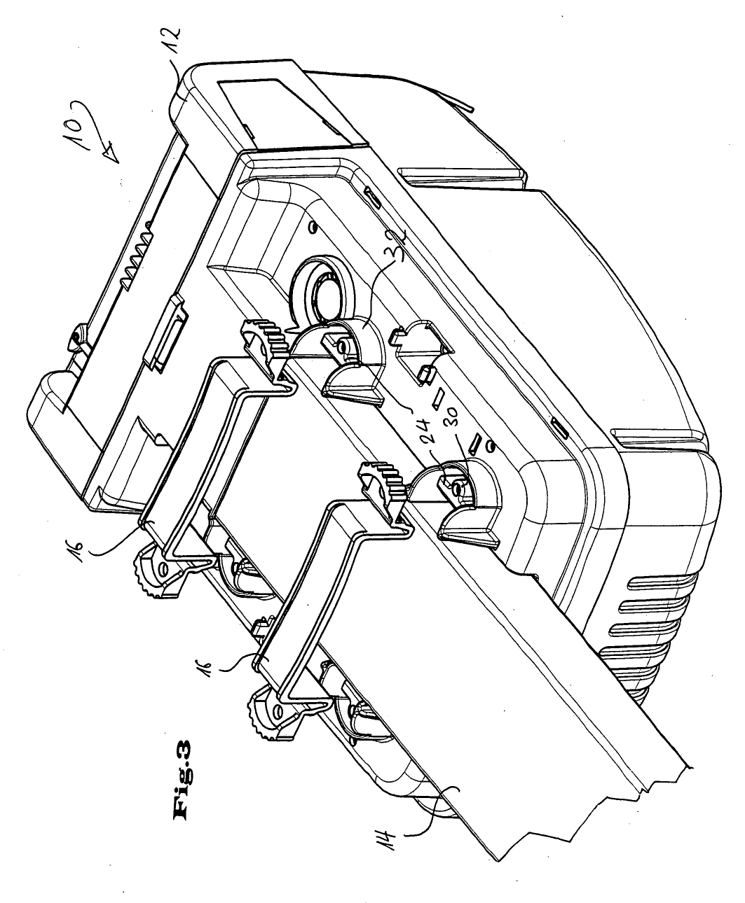

FIG. 3: a perspective representation of a garage door drive with the C-shaped holding elements prior to the installation; and

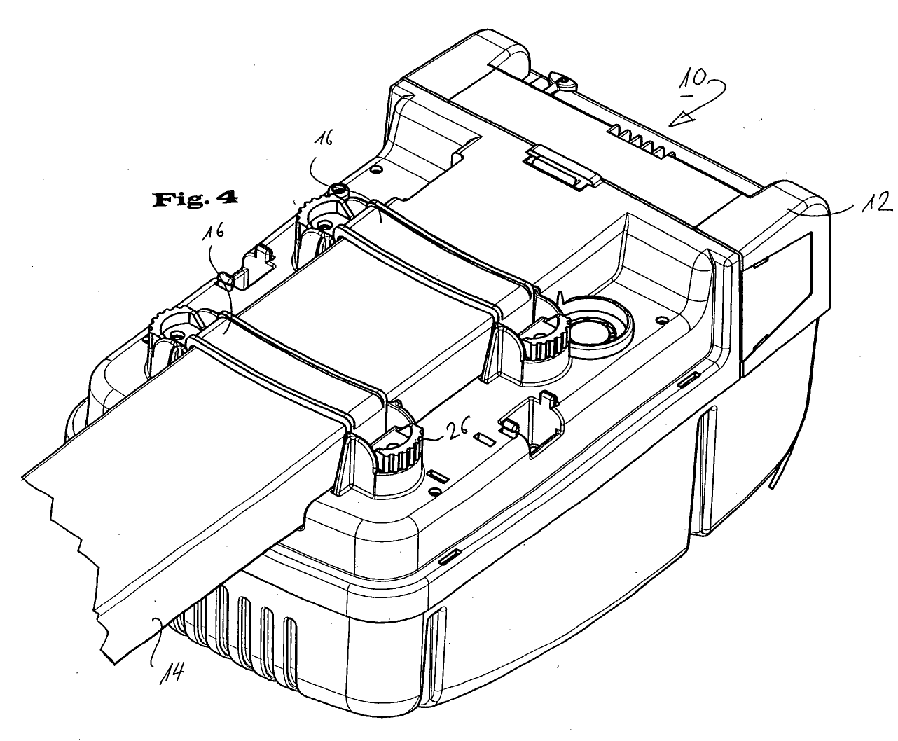

FIG. 4: a representation in accordance with FIG. 3 with the corresponding holding elements after the installation.

In FIG. 3, a garage door drive 10 is shown comprising a housing 12 surrounding the drive unit not shown in any detail here and a guide rail 14 which is releasably connectable to the housing. The translation not shown in any detail here, but in the customary manner for the person skilled in the art, of the rotational movement of the motor shaft into the linear movement of the guide carriage likewise not shown here takes place between the guide rail and the drive unit.

The guide carriage is moved over a toothed belt, a roller chain or the like, which are connected to the geared motor via a deflection toothed wheel or deflection pinion. In the embodiment shown here, the guide rail 14 is made as a C-shaped steel rail which can be latched to the housing 12 via two C-shaped holding clips 16 here such that the assembled arrangement in accordance with FIG. 4 results. The shape of the C-shaped holding clips 16 results from FIGS. 1 and 2. These C-shaped holding clips consisting of plastic have, on the one hand, resilient limbs 20 molded to their lateral limbs 18, with these being molded such that the shape of a U results. Latch noses 22 are injection molded to the resilient webs 20 and engage into corresponding cut-outs (not shown here) in molded elements 24 which are injection molded to the housing 12 likewise consisting of plastic (cf. FIG. 3). The corresponding latch noses 22 can latch into these cut-outs inside the molded elements 24 due to the spring property of the webs 20.

Tongues 24 are molded approximately perpendicular to the webs 20 and their outer rim 26 is reinforced and/or grooved. The grooving serves to increase the grip for the manual installation. The resilient webs 20 are pressed inwardly by a corresponding pressing together of the tongues in the direction of the arrows in accordance with FIG. 1 such that the latch noses 22 are no longer in engagement with the corresponding cut-outs in the molded elements 24. The holding clips can be easily removed in this position. In the assembled position, the spring force of the resilient webs 20 is sufficient to hold the latch noses 22 in a latched position inside the cut-out (now shown in detail) of the molded elements 24.

In addition, a screw bore 28 can be provided in the tongue, with only the screw connection of a safety screw being possible here which can be screwed into a corresponding screw bore 30 inside the housing. This screw connection only serves the additional security and is not necessary for the installation as such.

As shown in FIGS. 3 and 4, a protective wall 32 is molded to the housing 12, with the former, as shown in FIG. 3, surrounding the resilient webs 20, with the rim 26 of the tongue 24 projecting beyond a cut-out provided in the protective wall such that this rim region of the tongue 26 is movable manually from the outside in the direction of the arrow in accordance with FIG. 1. In the embodiment of the invention shown here, holding clips are shown which are clipped in from above. Alternatively to this, a corresponding resilient latch element can also be provided directly at the guide rail 14 instead of the holding clips. Instead of this clip connection, alternatively to the direct clipping connection to the drive unit and to the shown holding clips with a clipping direction from above, holding plug devices can naturally also be used from the front, the side or the bottom. What is important is the screw-free quick-assembly and quick dismantling of the two main assemblies of guide rail 14 and drive unit or its housing 12.

1. A garage door drive comprising a guide rail for the receiving of a drive means and a drive unit arranged in a housing, with the guide rail being releasably connectable to the housing, wherein the guide rail is adapted to be fixed to the housing by a structure formed on it and latchable into corresponding molded elements arranged on the housing.

2. A garage door drive in accordance with claim 1, wherein the structure comprises latching tongues formed on the guide rail, wherein the latchable tongues are adapted to be latchable into corresponding molded elements arranged on the housing.

3. A garage door drive in accordance with claim 1, wherein the structure comprises at least one C-shaped holding clip engaging around the guide rail and latchable into corresponding molded elements arranged on the housing.

4. A garage door drive in accordance with claim 3, wherein resilient webs adjoin the lateral limbs of the at least one C-shaped holding clip.

5. A garage door drive in accordance with claim 4, wherein latch elements are molded to the resilient webs and engage into corresponding latch elements of the molded elements on the housing.

6. A garage door drive in accordance with claim 4, wherein a respective tongue adjoins the resilient webs.

7. A garage door drive in accordance with claim 6, wherein a screw bore is cut-out in the tongue for the receiving of a safety screw.

8. A garage door drive in accordance with claim 7, wherein an outer rim of the tongue is reinforced and/or grooved.

9. A garage door drive in accordance with claim 8, wherein a protective wall is molded to the housing and surrounds the inserted resilient webs, and said rim of the tongue adjoining the resilient web projects beyond a cut-out provided in the protective wall.

10. A garage door drive in accordance with claim 1, wherein both the structure and the housing consist of plastic.
